(19) United States
(12) Patent Application Publication
(10) Pub. No.: US 2007/0258528 A1
(43) Pub. Date: Nov. 8, 2007

(54) Apparatus for reducing clipping noise in a broadband wireless communication system and method thereof

(75) Inventors: Jong-Hyung Kwun, Seongnam-si (KR); Eung-Sun Kim, Suwon-si (KR); Jong-Hyeuk Lee, Anyang-si (KR); Uj-Kun Kwon, Pohang-si (KR); Gi-Hong Im, Pohang-si (KR); Jung-Hun Ryu, Pohang-si (KR)

Correspondence Address: THE FARRELL LAW FIRM, P.C., 333 EARLE OVINGTON BOULEVARD, SUITE 701, UNIONDALE, NY, 11553, US

(73) Assignees: Samsung Electronics Co., Ltd., Suwon-si (KR); POSTECH FOUNDATION, Pohang-si (KR)

(21) Appl. No.: 11/787,433

(22) Filed: Apr. 16, 2007

(30) Foreign Application Priority Data
Apr. 14, 2006 (KR) 2006-0033820

(51) Int. Cl. H04L 27/28; H04L 25/08; H04L 1/00

(52) U.S. Cl. 375/260; 375/350; 375/346; 375/340

(57) ABSTRACT

Provided are an apparatus for reducing clipping noise in a broadband wireless communication system in which a clipping method is used and a method thereof. The method includes, when clipped signals are received, decoding and equalizing the received signals to determine transmitted symbols, comparing the magnitudes of the amplitudes of the determined transmitted symbols with a predetermined reference value, and reconstructing signals using the amplitudes of the transmitted symbols and the phases of the received signals when it is determined that the magnitudes of the amplitudes of the transmitted symbols are greater than the reference value.

### PRIORITY

This application claims priority under 35 U.S.C. § 119 to an application entitled “Apparatus For Reducing Clipping Noise In Broadband Wireless Communication System And Method Thereof” filed in the Korean Intellectual Property Office on Apr. 14, 2006 and assigned Serial No. 10-2006-33820, the contents of which are incorporated herein by reference.

### BACKGROUND OF THE INVENTION

1. Field of the Invention

The present invention relates generally to an apparatus for attenuating a Peak to Average Power Ratio (PAPR) using a clipping method in a broadband wireless communication system and a method thereof, and in particular, to an apparatus for reducing the clipping noise generated when clipping is performed in order to attenuate a PAPR in a broadband wireless communication system and a method thereof.

2. Description of the Prior Art

Multi-carrier transmission schemes such as an Orthogonal Frequency Division Multiplexing (OFDM) method and a Filtered Multi-Tone (FMT) method have an advantage in that they are robust in channel environments such as frequency selective fading and narrowband interference. However, since the multi-carrier transmission scheme has a high peak to average power ratio, the power efficiency of a transmission amplifier deteriorates and the non-linear distortion of transmitted signals is generated. There's ongoing research concerning methods of reducing the PAPR such as a Partial Transmit Sequence (PTS), clipping, and interleaving.

In the clipping method that is most easily and simply implemented, among the methods for reducing the PAPR, input signals of which the levels are higher than a reference value (a clipping ratio) are cut off. However, in the clipping method, since the parts higher than the reference value are cut off, performance deteriorates due to bit errors in in-band or the cut off parts can function as interference in adjacent communication channels in out of band. There is ongoing research concerning receiving methods for reducing the clipping noise such as a Decision-Aided Reconstruction (DAR) method having the structure illustrated in FIG. 1.

FIG. 1 is a block diagram of a receiving apparatus for reducing the clipping noise in the conventional art.

Referring to FIG. 1, the receiving apparatus includes a serial-to-parallel converter 101, a prototype filter 103, first and second Fast Fourier Transform (FFT) operators 105 and 119, an equalizer 107, first and second Inverse Fast Fourier Transform (IFFT) operators 109 and 115, a buffer 111, a signal determiner 113, and a signal reconstructing unit 117.

The serial-to-parallel converter 101 converts serial signals received through an antenna into parallel signals to output a parallel signals. The prototype filter 103 performs filtering in order to reduce the interference of sub-carriers in the parallel signals received from the serial-to-parallel converter 101.

The first FFT operator 105 performs FFT on the signals in a time domain that are received from the prototype filter 103 to convert the signals in the time domain into signals in a frequency domain and to output the signals in the frequency domain.

The equalizer 107 estimates the channels of the received signals to compensate for the channel distortions of the signals in the frequency domain that are received from the first FFT operator 105. Thereafter, the equalizer 107 transmits the signals in the frequency domain whose channel distortions are compensated for to the first IFFT operator 109 and the signal determiner 113.

The first IFFT operator 109 performs IFFT on the signals in the frequency domain that are received from the equalizer 107 to convert the signals in the frequency domain into the signals in the time domain. Then, the signals in the time domain are stored in the buffer 111.

In order to determine transmitted symbols to restore the signals damaged by the clipping noise, the signal determiner 113 performs a hard decision using the signals in the frequency domain that are received from the equalizer 107. Also in order to determine the transmitted symbols, the signal determiner 113 performs the hard decision using the signals reconstructed to restore the signals damaged by the clipping noised that are received from the second FFT operator 119.

The second IFFT operator 115 performs IFFT on the transmitted symbols in the frequency domain that are determined by the signal determiner 113 to convert the determined transmitted symbols in the frequency domain into the signals in the time domain and to output the signals in the time domain.

The signal reconstructing unit 117 compares the amplitudes of the transmitted symbols in the time domain that are received from the second IFFT operator 115 with a predetermined clipping ratio in order to restore the signals distorted by the clipping noise. Then, the signal reconstructing unit 117 reconstructs signals using the received signals stored in the buffer 111 and the transmitted symbols determined by the hard decision that are received from the second IFFT operator 115 in accordance with the comparison result.

For example, when the amplitudes of the transmitted symbols are at most the clipping ratio, the received signals stored in the buffer 111 are used as they are. Alternatively, when the amplitudes of the transmitted symbols are higher than the clipping ratio, the received signals are replaced by the transmitted symbols to reconstruct the signals. Then, in order to repeatedly perform the above-described processes, the signal reconstructing unit 117 transmits the reconstructed signals in the time domain to the second FFT operator 119.

According to the DAR method, as described above, to reduce the clipping noise, the amplitudes of the transmitted symbols determined by the hard decision are compared with the predetermined clipping ratio. Then, signals are reconstructed in accordance with the comparison result to restore the signals damaged by the clipping noise.

However, in the DAR method, operations are performed only in a high clipping ratio. That is, when the clipping ratio is no more than 4 dB, performance rapidly deteriorates. Furthermore, since the DAR method is designed to restore Nyquist-sampled signals, when the DAR method is applied to an over-sampled system, performance is not highly improved.

### SUMMARY OF THE INVENTION

Accordingly, the present invention has been made to solve the above-mentioned problems occurring in the prior art, and an object of the present invention is to provide an apparatus for reducing clipping noise in a broadband wireless communication system in which a clipping method is used for attenuating a Peak to Average Power Ratio (PAPR) and a method thereof.

Another object of the present invention is to provide an apparatus for reducing the clipping noise of over-sampled signals in a broadband wireless communication system in which a clipping method is used for attenuating a PAPR and a method thereof.

Still another object of the present invention is to provide an apparatus for reconstructing signals using the amplitudes of signals determined by a hard decision and received signals in a broadband wireless communication system in which a clipping method is used for attenuating a PAPR to reduce clipping noise and a method thereof.

Still yet another object of the present invention is to provide an apparatus for limiting out of band signals and transmitting the limited out of band signals in order to reduce the clipping noise of over-sampled signals in a broadband wireless communication system in which a clipping method is used for attenuating a PAPR and a method thereof.

Still further another object of the present invention is to provide an apparatus for restoring out of band signals limited by a transmitting end in a broadband wireless communication system in which a clipping method is used for attenuating a PAPR to reduce clipping noise and a method thereof.

According to an aspect of the present invention, there is provided a method of reducing clipping noise in a broadband wireless communication system in which a clipping method is used, the method including, when clipped signals are received, decoding and equalizing the received signals to determine transmitted symbols, comparing the magnitudes of the amplitudes of the determined transmitted symbols with a predetermined reference value, and reconstructing signals using the amplitudes of the transmitted symbols and the phases of the received signals when it is determined that the magnitudes of the amplitudes of the transmitted symbols are greater than the reference value.

According to another aspect of the present invention, there is provided a receiving apparatus for reducing clipping noise in a broadband wireless communication system in which a clipping method is used, the apparatus including an equalizer for estimating the channels of received signals to compensate for channel distortions; a signal determiner for determining transmitted symbols using the received signals whose channel distortions are compensated for; and a signal reconstructing unit for comparing the amplitudes of the determined transmitted symbols with a predetermined reference value in order to reduce the clipping noise to reconstruct signals using the amplitudes determined in accordance with the comparison result and the phases of the received signals.

According to still another aspect of the present invention, there is provided a transmitting apparatus for limiting out of band signal in a broadband wireless communication system in which a clipping method is used, the apparatus including a first IFFT operator for performing IFFT on transmitted signals to convert the transmitted signals into signals in a time domain; a clipper for clipping the parts of the levels of the signals in the time domain that are greater than a predetermined clipping ratio, and an out of band signal limiter for converting the clipped signals in the time domain into signals in a frequency domain to limit out of band signals and for converting the signals in which the out of band signals are limited into signals in a time domain to output the signals in the time domain.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a conventional receiving apparatus for reducing clipping noise;

FIG. 2 is a block diagram of a transmitting apparatus for removing out of band signals according to a first embodiment of the present invention;

FIG. 3 is a block diagram of a transmitting apparatus for removing out of band signals according to a second embodiment of the present invention;

FIG. 4 is a block diagram of a receiving apparatus for reducing clipping noise according to the present invention;

FIG. 5 is a block diagram of an apparatus for reconstructing signals according to the present invention;

FIG. 6 is a flowchart illustrating processes of reducing clipping noise according to the present invention;

FIG. 7 is a graph illustrating signals clipped according to the present invention;

FIGS. 8A and 8B are graphs illustrating that performance is improved according to the first embodiment of the present invention; and

FIGS. 9A and 9B are graphs illustrating that performance is improved according to the second embodiment of the present invention.

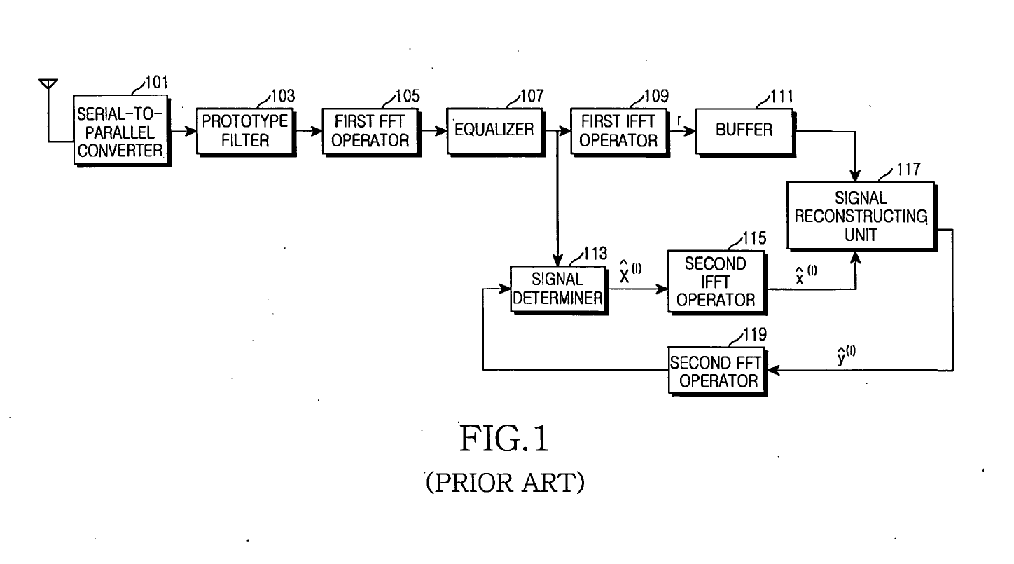

### DETAILED DESCRIPTION OF THE PREFERRED EMBODIMENTS

Hereinafter, preferred embodiments of the present invention will be described with reference to the accompanying drawings. In describing the present invention, when it is determined that detailed description of related well-known functions or structures may undesirably make the subject matter of the present invention vague, the detailed description thereof will be omitted.

Described hereinafter is a technology of reducing clipping noise in a broadband wireless communication system in which a clipping method is used for attenuating a Peak to Average Power Ratio (PAPR). As an example, a description will given of a broadband wireless communication system in which a Filtered Multi-Tone (FMT) method is used. The present invention is also applicable to a broadband wireless communication system in which a multi-carrier communication system such as an Orthogonal Frequency Division Multiplexing (OFDM) method is used.

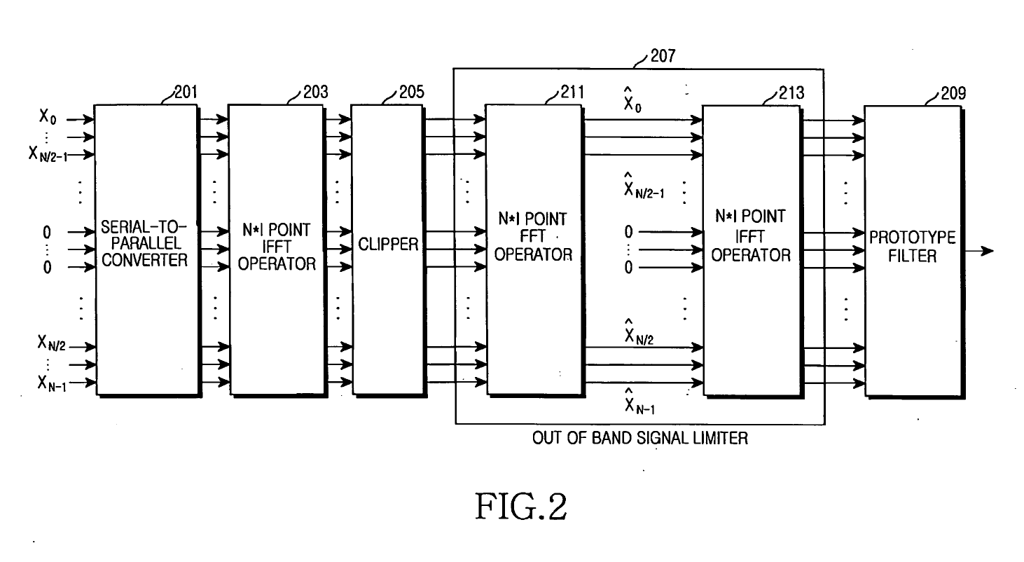

Hereinafter, after performing clipping of over-sampled signals, in order to solve the problem in that out of band signals are generated, as illustrated in FIG. 2, the out of band signals are limited to be transmitted.

FIG. 2 is a block diagram of a transmitting apparatus for removing out of band signals according to a first embodiment of the present invention. Hereinafter, a description of an over-sampled system will be set forth as an example.

As illustrated in FIG. 2, a transmitting apparatus includes a serial-to-parallel converter 201, a first Inverse Fast Fourier Transform (IFFT) operator 203, a clipper 205, an out of band signal limiter 207, and a prototype filter 209.

The serial-to-parallel converter 201 converts serial signals coded and modulated in accordance with corresponding code rate and modulating method into parallel signals to output the parallel signals. The first IFFT operator 203 performs IFFT on the signals in a frequency domain that are received from the serial-to-parallel converter 201 to convert the signals in the frequency domain into signals in a time domain.

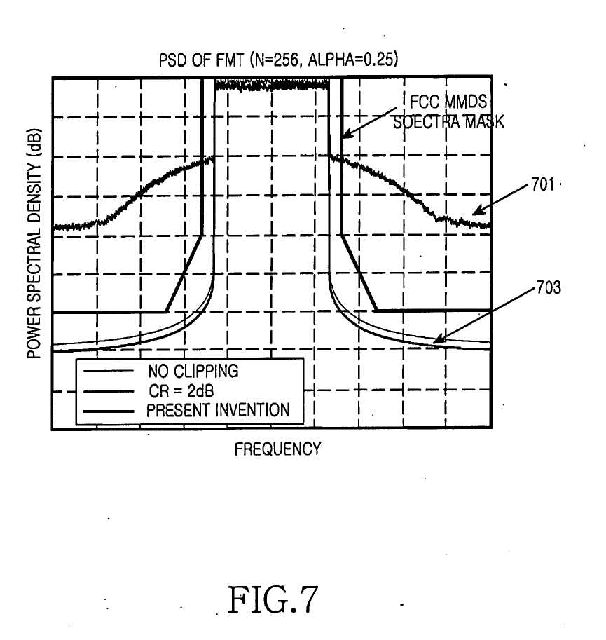

The clipper 205 clips signals whose levels are higher than a predetermined clipping ratio among the signals in the time domain that are received from the first IFFT operator 203 to output the clipped signals. As illustrated in FIG. 7, in the clipped signals, out of band signals such as signal 701 are generated.

The out of band signal limiter 207 includes an FFT operator 211 and a second IFFT operator 213 to limit the out of band signals in the signals received from the clipper 205. That is, the FFT operator 211 performs FFT on the signals in the time domain that are received from the clipper 205 to convert the signals in the time domain into the signals in the frequency domain and to output the signals in the frequency domain to limit the out of band signals in the frequency domain.

The second IFFT operator 213 sets out of band signal periods in the signals in the frequency domain that are received from the FFT operator 211 to 0, and then performs IFFT to limit the out of band signals. For example, as illustrated in FIG. 7, when the over-sampled signals are clipped, the out of band signals such as signal 701 are generated. At this time, the out of band signals such as a signal 703 are limited using the out of band signal limiter 207.

The prototype filter 209 performs filtering in order to reduce the interference of sub-carriers in the signals received from the out of band signal limiter 207.

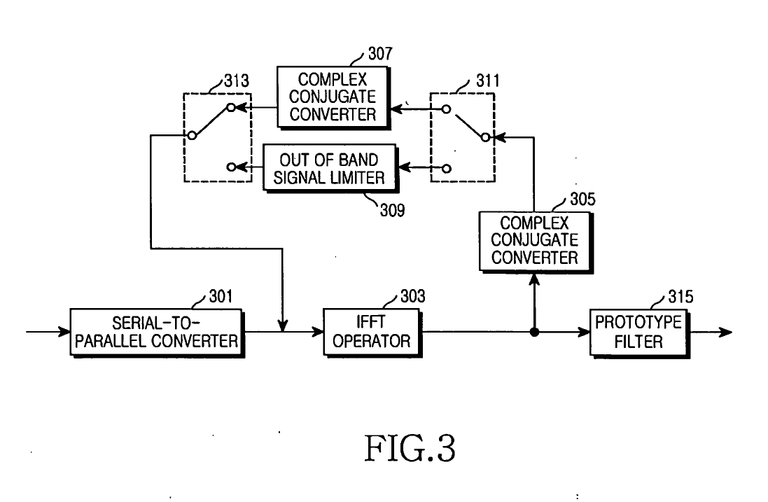

As described above, the out of band signal limiter 207 limits the out of band signals generated by performing clipping. In this case, the transmitting apparatus having the structure illustrated in FIG. 3 may be used to prevent the FFT operator 211 and the second IFFT operator 213 from being added.

FIG. 3 is a block diagram of a transmitting apparatus for removing out of band signals according to a second embodiment of the present invention.

As illustrated in FIG. 3, the transmitting apparatus includes a serial-to-parallel converter 301, an IFFT operator 303, a complex conjugate converter 305, a clipper 307, an out of band signal limiter 309, first and second switches 311 and 313, and a prototype filter 315.

The serial-to-parallel converter 301 converts serial signals coded and modulated in accordance with corresponding code rate and modulating method into parallel signals to output the parallel signals.

The IFFT operator 303 performs IFFT on the signals in a frequency domain that are received from the serial-to-parallel converter 301 to convert the signals in the frequency domain into signals in a time domain. Then, the IFFT operator 303 repeatedly performs IFFT on the signals in the frequency domain that are received from the clipper 307 or the out of band signal limiter 309 a predetermined number of times to convert the signals in the frequency domain into signals in the time domain. Also, the IFFT operator 303 outputs the signals in the time domain to the prototype filter 315 after twice repeating the above-described processes.

The complex conjugate converter 305 complex conjugate converts the signals output from of the IFFT operator 303 to perform FFT without adding the FFT operator using only the IFFT operator 303. Simply, the complex conjugate converter 305 allows the same function as FFT to be performed when the IFFT signals are complex conjugate converted as illustrated in Equation (1) below:
FFT(x)=(IFFT(x*))* (1)

wherein, x* represents that first feedback signals are complex conjugate converted and (IFFT(x*))* represents that second feedback signals are complex conjugate converted. That is, the (IFFT(x*))* have the same values as FFT values.

The first switch 311 and the second switch 313 connect the output signals of the complex conjugate converter 305 to the clipper 307 or the out of band signal limiter 309 in accordance with the number of times of repeating. For example, the first switch 311 and the second switch 313 are connected to the clipper 307 in the case of the first repetition and are connected to the out of band signal limiter 309 in the case of the second repetition.

The clipper 307 clips signals whose levels are higher than the predetermined clipping ratio among the signals in the time domain that are received from the complex conjugate converter 305 to output the clipped signals. At this time, as illustrated in FIG. 7, the out of band signals such as the signal 701 are generated in the clipped signals. Here, the clipper 307 performs clipping using only the amplitudes of the signals. Therefore, since the amplitudes of the signals are calculated by the squares of the complex values of the signals (signals I and Q), there is no change in performance when clipping is performed using the output signals of the complex conjugate converter 305.

The out of band signal limiter 309 sets out of band signal periods in the signals in the frequency domain that are received from the complex conjugate converter 305 to 0 to output 0. Then, the IFFT operator 303 performs IFFT on the signals in the frequency domain in which the out of band signals are limited to convert the signals in the frequency domain into signals in the time domain.

The prototype filter 315 performs filtering in order to reduce the interference of sub-carriers in the signals where the out of band signals are limited that are received from the IFFT operator 303.

Hereinafter, an apparatus for performing clipping as illustrated in FIGS. 2 and 3 and receiving signals transmitted after out of band signals are limited to reduce clipping noise and a method thereof will be described. Here, when clipping is performed, since only the amplitudes of the transmitted signals are distorted, only the amplitudes of the signals are restored in the process of restoring the signals and the phases of received signals are used, which will be described.

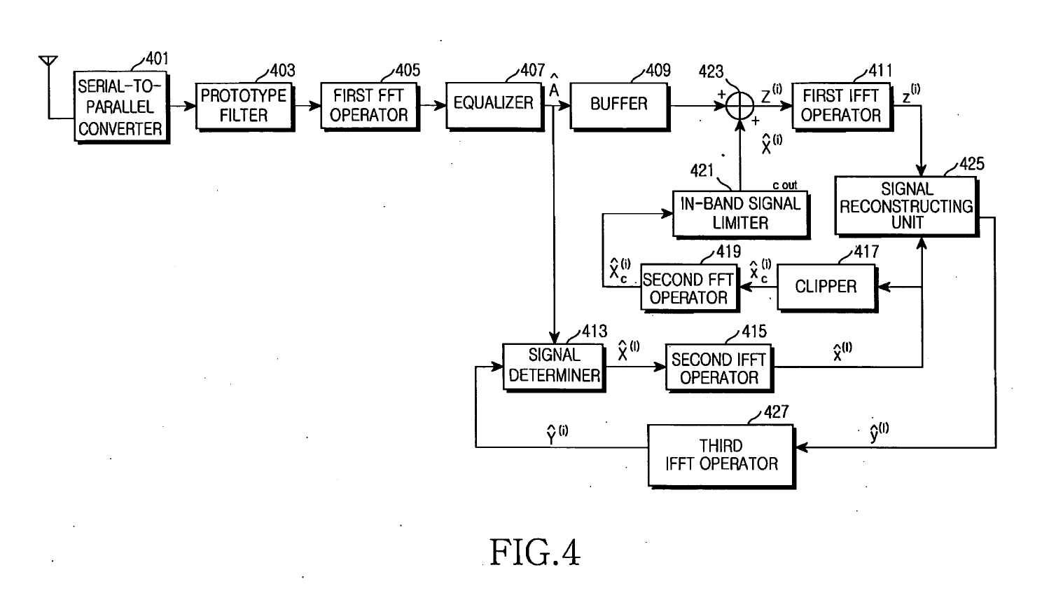

FIG. 4 is a block diagram of a receiving apparatus for reducing clipping noise according to the present invention. As illustrated in FIG. 4, the receiving apparatus includes a serial-to-parallel converter 401, a prototype filter 403, first, second, and third FFT operators 405, 419, and 427, an equalizer 407, a buffer 409, first and second IFFT operators 411 and 415, a signal determiner 413, a clipper 417, an in-band signal limiter 421, an adder 423, and a signal reconstructing unit 425.

The serial-to-parallel converter 401 converts serial signals received through an antenna into parallel signals to output the parallel signals. The prototype filer 403 performs filtering in order to reduce the interference of sub-carriers in the parallel signals received from the serial-to-parallel converter 401.

The first FFT operator 405 performs FFT on the signals in a time domain that are received from the prototype filter 403 to convert the signals in the time domain into signals in a frequency domain and to output the signals in the frequency domain.

The equalizer 407 estimates the channels of the received signals to compensate for the channel distortions of the signals in the frequency domain that are received from the first FFT operator 405. Then, the equalizer 407 transmits the signals Â in the frequency domain whose channel distortions are compensated for to the buffer 409 and the signal determiner 413.

The signal determiner 413 determines transmitted symbols \hat{X}⁽ⁱ⁾ by a hard decision using the signals in the frequency domain that are received from the equalizer 407.

Also, the signal determiner 413 performs the hard decision using the signals Ŷ⁽ⁱ⁾ reconstructed to restore the signals damaged by the clipping noise that are received from the third FFT operator 427 to determine the transmitted symbols.

The second IFFT operator 415 performs IFFT on the transmitted symbols in the frequency domain that are determined by the signal determiner 413 to convert the transmitted symbols in the frequency domain into the signals \hat{x}⁽ⁱ⁾ in the time domain and to output the signals \hat{x}⁽ⁱ⁾ in the time domain. At this time, the second IFFT operator 415 transmits the transmitted symbols converted into the signals in the time domain to the signal reconstructing unit 425 for reconstructing signals and the clipper 417 for re-generating the out of band signals removed from the transmitting end.

The clipper 417 clips the signals in the time domain that are received from the second IFFT operator 415 in the same ratio as the clipping ratio in which clipping is performed by the transmitting end. The second FFT operator 419 performs FFT on the clipped signals \hat{x}_{c}⁽ⁱ⁾ in the time domain that are received from the clipper 417 to re-generate only the out of band signals in the frequency domain and converts the clipped signals \hat{x}_{c}⁽ⁱ⁾ in the time domain into the signals \hat{X}_{c}⁽ⁱ⁾ in the frequency domain.

The in-band signal limiter 421 limits in-band signals and outputs the limited in-band signals to re-generate only out of band signals \hat{X}_{c}_{_{—}}ₒᵤₜ⁽ⁱ⁾ in the signals in the frequency domain that are received from the second FFT operator 419.

The adder 423 adds the out of band signals(Z⁽ⁱ⁾) re-generated by the in-band signal limiter 421 to the in-band received signals stored in the buffer 409. Then, the first IFFT operator 411 performs IFFT on the signals in the frequency domain that are received from the adder 423 to convert the signals in the frequency domain into signals z⁽ⁱ⁾ in the time domain.

The signal reconstructing unit 425 compares the amplitudes of the signals in the time domain that are received from the second IFFT operator 415 with a predetermined clipping ratio in order to restore the signals distorted by the clipping noise. Then, in accordance with the comparison result, signals are reconstructed as illustrated in Equation (2).

$${\hat{y}}_{k}^{( i )} = \{ \begin{matrix}{z}_{k}^{( i )} & \vert {\hat{x}}_{k}^{( i )} \vert \leq A , \\ \vert {\hat{x}}_{k}^{( i )} \vert exp \{ arg ( {z}_{k}^{( i )} ) \} & \vert {\hat{x}}_{k}^{( i )} \vert > A , 0 \leq k \leq IN - 1\end{matrix} \qquad ( 2 )$$

wherein, the zₖ represents received signals to which the out of band signals are added and the |\hat{x}ₖ⁽ⁱ⁾| represents the magnitudes of the amplitudes of the transmitted symbols determined by the signal determiner 413. Also, the arg(zₖ⁽ⁱ⁾) represents the phases of the received signals, the A represents a reference clipping ratio, and the i represents the repeating number of times for reducing the clipping noise.

Referring to the Equation (2), the received signals to which the out of band signals are added are used “as they are” when the amplitudes of the transmitted symbols are less than or equal to the clipping ratio. Alternatively, when the amplitudes of the transmitted symbols are greater than the clipping ratio, signals are reconstructed using the amplitudes of the transmitted symbols that are determined by the signal determiner 413 and the phases of the received signals.

Then, the signal reconstructing unit 425 transmits the reconstructed signals in the time domain to the third FFT operator 427 in order to repeatedly perform the above processes.

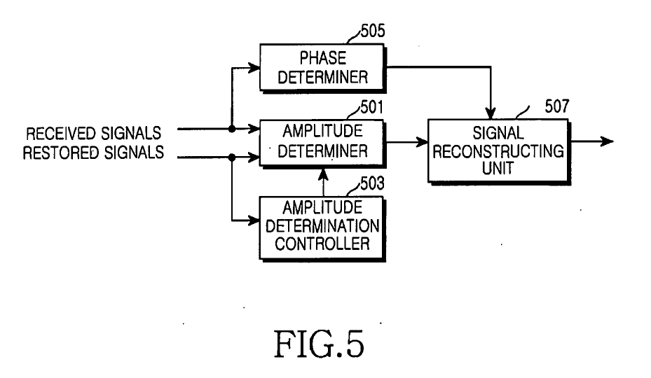

The signal reconstructing unit 425 for comparing the amplitudes of the transmitted symbols determined by the hard decision with the clipping ratio as described above to reconstruct signals has the detailed structure illustrated in FIG. 5.

FIG. 5 is a block diagram of an apparatus for reconstructing signals according to the present invention. As illustrated in FIG. 5, the signal reconstructing unit 425 includes an amplitude determiner 501, an amplitude determination controller 503, a phase determiner 505, and a signal reconstructing unit 507.

First, the amplitude determiner 501 determines amplitudes for reconstructing signals among the received signals to which the out of band signals are added that are received from the first IFFT operator 411 and the transmitted symbols determined by performing the hard decision that are received from the second IFFT operator 415 in accordance with the control of the amplitude determination controller 503.

The amplitude determination controller 503 compares the amplitudes of the transmitted symbols determined by performing the hard decision that are received from the second IFFT operator 415 with the predetermined clipping ratio to generate a control signal for selecting amplitudes to reconstruct signals. For example, when the amplitudes of the transmitted symbols are greater than the clipping ratio, the amplitude determination controller 503 generates the control signal to select the amplitudes of the transmitted symbols. Also, when the amplitudes of the transmitted symbols are less than or equal to the clipping ratio, the amplitude determination controller 503 generates the control signal to select the amplitudes of the received signals.

The phase determiner 505 determines the phases of the received signals to which the out of band signals are added that are received from the first IFFT operator 411.

The signal reconstructing unit 507 reconstructs signals using the amplitudes received from the amplitude determiner 501 and the phase values of the received signals that are received from the phase determiner 505 to output the reconstructed signals.

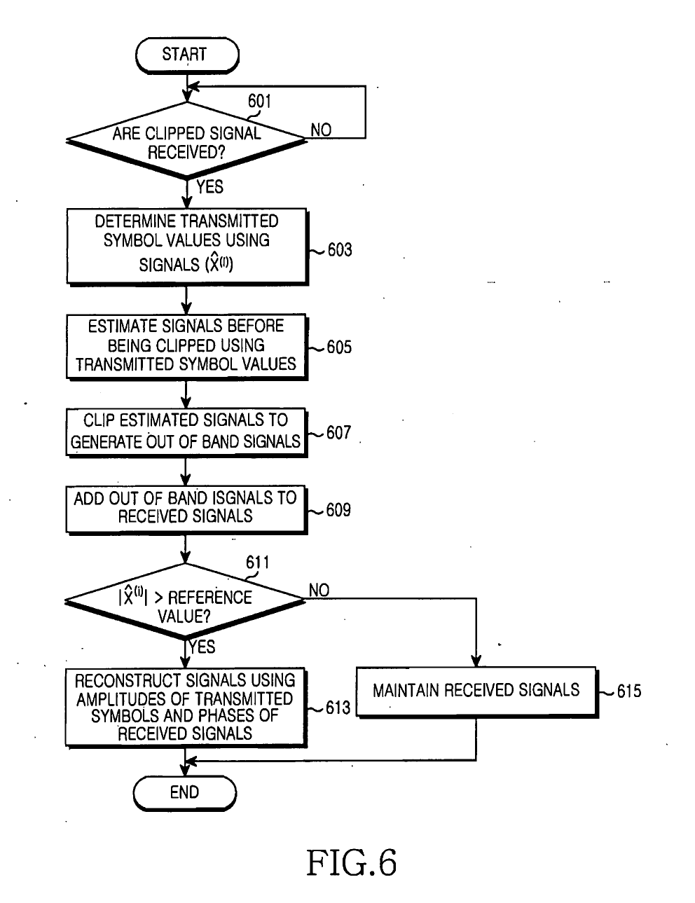

FIG. 6 is a flowchart illustrating processes of reducing clipping noise according to the present invention. Referring to FIG. 6, the receiving apparatus determines whether clipped signals are received from a transmitting end in step 601. Upon determining, in step 601, that the clipped signals are received, the process proceeds to step 603 in which the receiving apparatus demodulates and equalizes the received signals and then, performs a hard decision to determine transmitted symbols \hat{X}⁽ⁱ⁾. At this time, the demodulated and equalized received signals are stored in the buffer 409.

After determining the transmitted symbols, the process proceeds to step 605 in which the receiving apparatus performs IFFT on the determined transmitted symbols to calculate signals in a time domain and to estimate signals before being clipped by the transmitting end.

Then, the process proceeds to step 607 in which the receiving apparatus re-generates out of band signals limited by the transmitting end using the estimated signals. For example, in order to re-generate the limited out of band signals, first, the estimated signals are clipped in the same clipping ratio as the clipping ratio in which clipping is performed by the transmitting end. Then, FFT is performed on the clipped signals in the time domain to convert the clipped signals in the time domain into signals in a frequency domain and to limit in-band signals. That is, the in-band signal periods in the signals in the frequency domain are set to 0 so that only the out of band signals are left.

After re-generating the out of band signals, the process proceeds to step 609 in which the receiving apparatus adds the re-generated out of band signals to the received signals stored in the buffer 409.

Then, the process proceeds to step 611 in which the receiving apparatus compares the magnitudes |\hat{x}⁽ⁱ⁾| of the amplitudes of the determined transmitted symbols with a predetermined reference value A (clipping ratio) in order to restore the signals damaged by the clipping noise. When the magnitudes of the amplitudes of the transmitted symbols are greater than the reference value (|\hat{x}⁽ⁱ⁾|>A), the process proceeds to step 613 in which the receiving apparatus reconstructs signals using the amplitudes of the transmitted symbols and the phases of the received signals. Thereafter, the process is terminated.

Alternatively, when the magnitudes of the amplitudes of the transmitted symbols are less than or equal to the reference value (|\hat{x}⁽ⁱ⁾|≦A), the process proceeds to step 615 in which the receiving apparatus uses, without changes, the received signals to which the out of band signals are added. Thereafter, the process is terminated.

As described above, in the over-sampled system, the out of band signals limited by the transmitting end are re-generated to be added to the received signals so that the clipping noise is removed and that performance is improved. When the over-sampled system is not used, the process of re-generating the out of band signals may not be performed. Also, although the out of band signals limited by the transmitting end are re-generated to be added to the received signals so that the Decision-Aided Reconstruction (DAR) method is applied, it is possible to remove the clipping noise of the over-sampled system.

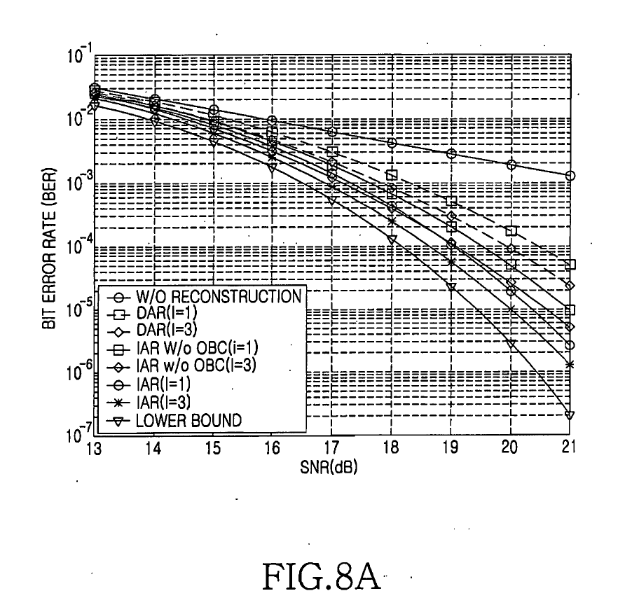

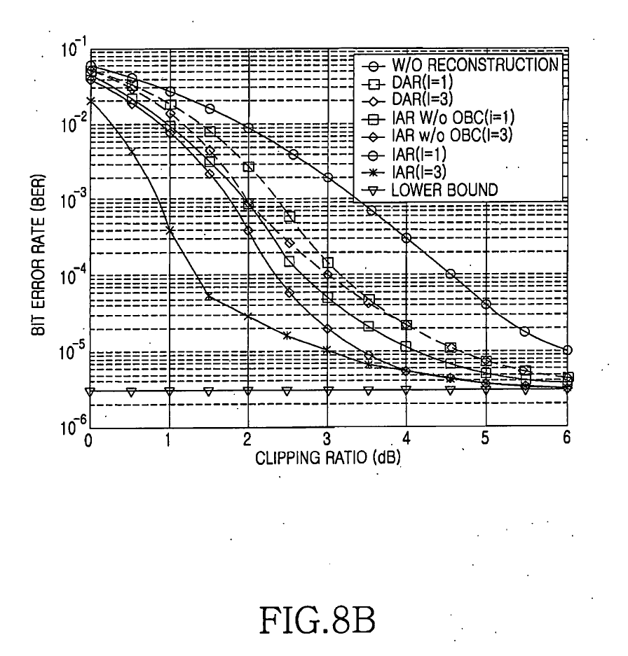

FIGS. 8A and 8B are graphs illustrating that performance is improved according to the first embodiment of the present invention. Hereinafter, the axis of abscissa represents a signal to noise ratio and the axis of ordinate represents a bit error rate. Also, the over-sampled system will be taken as an example.

Referring to FIGS. 8A and 8B, in the case where 512 sub-carriers, 640 FMT sampling coefficients, 8 filter periods, and 4 over-sample ratios are used, FIG. 8A represents changes in the bit error rate for the signal to noise ratio when it is assumed that the clipping ratio is 3.0 dB and FIG. 8B represents changes in the bit error rate for the signal to noise ratio when it is assumed that the clipping ratio is 1.5 dB.

As illustrated in FIG. 8A, in the case where the out of band signals are not re-generated and where the process of the present invention, that is, Iterative Amplitude Reconstruction (IAR) is applied, the bit error rates for the signal to noise ratios are lower, in comparison with the case where the DAR is used. Also, in the IAR method, in the case where the out of band signals are re-generated to be added, the bit error rates for the signal to noise ratios are lower, in comparison with the IAR method where the out of band signals are not re-generated.

As illustrated in FIG. 8B, like in FIG. 8A, the bit error rates for the signal to noise ratios are lower in the case where the IAR method is used in comparison with the case where the DAR method is used.

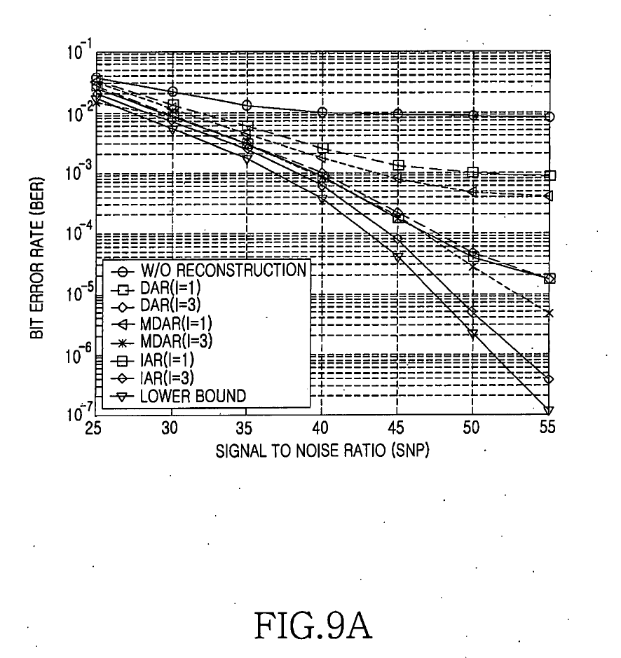

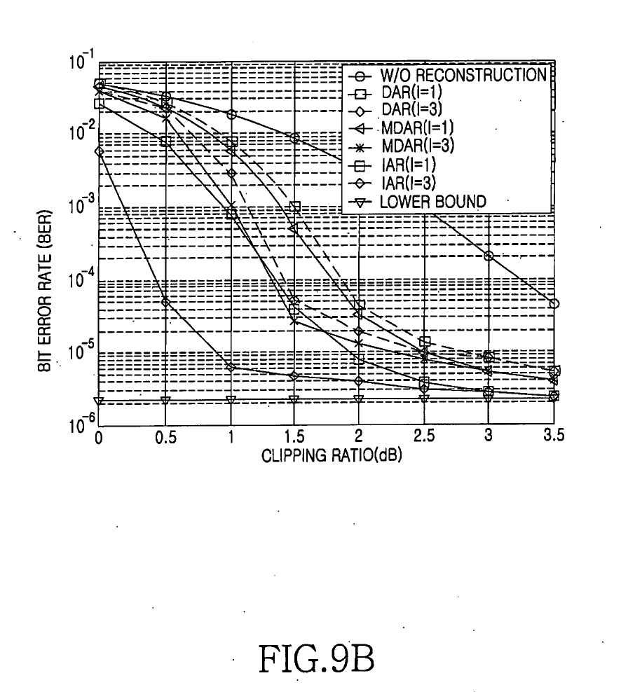

FIGS. 9A and 9B are graphs illustrating that performance is improved according to the second embodiment of the present invention. Hereinafter, the axis of abscissa represents a clipping ratio and the axis of ordinate represents a bit error rate. Also, the over-sampled system will be taken as an example.

Referring to FIGS. 9A and 9B, in the case where 512 sub-carriers, 640 FMT sampling coefficients, 8 filter periods, and 4 over-sample ratios are used, FIG. 9A represents changes in the bit error rate for the clipping ratio when it is assumed that the signal to noise ratio is 20.0 dB and FIG. 9B represents changes in the bit error rate for the clipping ratio when it is assumed that the signal to noise ratio is 50 dB.

As illustrated in FIGS. 9A and 9B, in the case where the amplitudes of the reconstructed signals are determined in accordance with the magnitudes of the amplitudes of the transmitted symbols on which the hard decision is performed while using the phases of the received signals as they are according to the present invention, it is possible to obtain lower bit error rates in low clipping ratios in comparison with the DAR method.

As described above, in the broadband wireless communication system, the out of band signals are limited to be transmitted by the transmitting end, the limited out of band signals are re-generated, the phases of the received signals are used, and the amplitudes of the transmitted symbols or the amplitudes of the received signals are used in accordance with the magnitudes of the amplitudes of the transmitted symbols determined by the hard decision to reconstruct signals so that it is possible to reduce the clipping noise even when the low clipping ratio is used or even in the Nyquist-sampled and over-sampled systems.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of reducing clipping noise in a wireless communication system, the method comprising the steps of:
decoding and equalizing received signals to determine transmitted symbols when clipped signals are received;
comparing magnitudes of the amplitudes of the determined transmitted symbols with a reference value; and
reconstructing signals using the amplitudes of the transmitted symbols and phases of the received signals when it is determined that the magnitudes of the amplitudes of the transmitted symbols are greater than the reference value.

2. The method as claimed in claim 1, wherein the reference value is a clipping ratio.

3. The method as claimed in claim 1, further comprising reconstructing signals using the amplitudes and the phases of the received signals when it is determined that the magnitudes of the amplitudes of the transmitted symbols are less than or equal to the reference value.

4. The method as claimed in claim 1, further comprising:
re-generating out of band signals limited by a transmitting end using the determined transmitted symbols when the received signals are over-sampled;
adding the re-generated out of band signals to the received signals; and
reconstructing signals using the received signals to which the out of band signals are added when it is determined that the magnitudes of the amplitudes of the transmitted symbols are less than or equal to the reference value.

5. The method as claimed in claim 4, wherein re-generating the out of band signals comprises:
performing Inverse Fast Fourier Transform (IFFT) on the determined transmitted symbols to convert the determined transmitted symbols into signals in a time domain;
clipping the signals in the time domain in a clipping ratio which is the same as a clipping ratio in which clipping is performed by the transmitting end; and
limiting in-band signals after converting the clipped signals into signals in a frequency domain.

6. The method as claimed in claim 4, further comprising reconstructing signals using the amplitudes of the transmitted symbols and the phases of the received signals to which the out of band signals are added when it is determined that the magnitudes of the amplitudes of the transmitted symbols are greater than the reference value.

7. The method as claimed in claim 1, wherein the transmitted symbols are determined by performing a hard decision.

8. The method as claimed in claim 1, wherein reconstructing the signals further comprises:
performing IFFT on the transmitted symbols; and
performing IFFT on the received signals, and wherein reconstructing the signals is performed in a time domain.

9. A method of reducing clipping noise in a wireless communication system, the method comprising the steps of:
decoding and equalizing received signals to determine transmitted symbols when clipped signals are received;
re-generating out of band signals limited by a transmitting end using the determined transmitted symbols;
adding the re-generated out of band signals to the received signals; and
comparing magnitudes of the amplitudes of the transmitted symbols with a reference value to reconstruct signals in accordance with the comparison result.

10. The method as claimed in claim 9, wherein the reference value is a clipping ratio.

11. The method as claimed in claim 9, further comprising reconstructing signals using the transmitted symbols when it is determined that the magnitudes of the amplitudes of the transmitted symbols are greater than the reference value.

12. The method as claimed in claim 9, wherein signals are reconstructed using the received signals to which the out of band signals are added when it is determined the magnitudes of the amplitudes of the transmitted symbols are less than or equal to the reference value.

13. The method as claimed in claim 9, wherein re-generating the out of band signals comprises:
performing Inverse Fast Fourier Transform (IFFT) on the determined transmitted symbols to convert the determined transmitted symbols into signals in a time domain;
clipping the signals in the time domain in a clipping ratio which is the same as a clipping ratio in which clipping is performed by the transmitting end; and
limiting in-band signals after converting the clipped signals into signals in a frequency domain.

14. The method as claimed in claim 9, wherein the transmitted symbols are determined by performing a hard decision.

15. The method as claimed in claim 9,
wherein reconstructing the signals further comprises:
performing IFFT on the transmitted symbols; and
performing IFFT on the received signals, and
wherein reconstructing the signals is performed in a time domain.

16. A method of re-generating out of band signals limited by a transmitting end in a wireless communication system, the method comprising the steps of:
decoding and equalizing received signals to determine transmitted symbols when signals in which the out of band signals are limited are received;
clipping the determined transmitted symbols in a clipping ratio which is the same as a clipping ratio in which clipping is performed by the transmitting end;
limiting in-band signals of the clipped signals; and
adding the clipped signals in which the in-band signals are limited to the received signals.

17. The method as claimed in claim 16, wherein clipping the determined transmitted symbols comprises:
performing Inverse Fast Fourier Transform (IFFT) on the transmitted symbols to convert the transmitted symbols into signals in a time domain; and
clipping the signals in the time domain in the same clipping ratio as the clipping ratio in which clipping is performed by the transmitting end.

18. The method as claimed in claim 16, wherein limiting the in-band signals comprises:
performing Fast Fourier Transform (FFT) on the clipped signals to convert the clipped signals into signals in a frequency domain; and
limiting in-band signals in the signals in the frequency domain.

19. A receiving apparatus for reducing clipping noise in a wireless communication system, the apparatus comprising:
an equalizer for estimating channels of received signals to compensate for channel distortions;
a signal determiner for determining transmitted symbols using the received signals whose channel distortions are compensated for; and
a signal reconstructing unit for comparing amplitudes of the determined transmitted symbols with a reference value in order to reduce clipping noise to reconstruct signals using the amplitudes determined in accordance with the comparison result and phases of the received signals.

20. The apparatus as claimed in claim 19, wherein the reference value is a clipping ratio.

21. The apparatus as claimed in claim 19, wherein the signal determiner determines transmitted symbols by a hard decision using the received signals whose channel distortions are compensated for.

22. The apparatus as claimed in claim 19, further comprising:
a first Inverse Fast Fourier Transform (IFFT) operator for performing IFFT on the transmitted symbols; and
a second IFFT operator for performing IFFT on the received signals whose channel distortions are compensated for,
wherein the signal reconstructing unit reconstructs signals in a time domain.

23. The apparatus as claimed in claim 19, wherein the signal reconstructing unit compares the amplitudes of the transmitted symbols with the reference value to reconstruct signals using the amplitudes of the transmitted symbols and phases of the received signals when it is determined that the amplitudes of the transmitted symbols are greater than the reference value and to reconstruct signals using the received signals when it is determined that the amplitudes of the transmitted symbols are less than or equal to the reference value.

24. The apparatus as claimed in claim 19, further comprising:
an out of band signal re-generator for re-generating out of band signals limited by a transmitting end using transmitted symbols determined by the signal determiner when the received signals are over-sampled; and
an adder for adding the re-generated out of band signals to the output signals of the equalizer.

25. The apparatus as claimed in claim 24, wherein the out of band signal re-generator comprises:
an IFFT operator for performing IFFT on the transmitted symbols to convert the transmitted symbols into signals in a time domain;
a clipper for clipping the signals in the time domain in a clipping which is the same ratio as a clipping ratio in which clipping is performed by the transmitting end;
a Fast Fourier Transform (FFT) operator for performing FFT on the clipped signals to convert the clipped signals into signals in a frequency domain; and
an in-band signal limiter for limiting in-band signals in the clipped signals in the frequency domain.

26. A transmitting apparatus for limiting out of band signals in a wireless communication system, the apparatus comprising:
a first Inverse Fast Fourier Transform (IFFT) operator for performing IFFT on transmitted signals to convert the transmitted signals into signals in a time domain;
a clipper for clipping parts of the levels of the signals in the time domain that are greater than a predetermined clipping ratio; and
an out of band signal limiter for converting the clipped signals in the time domain into signals in a frequency domain to limit out of band signals and for converting the signals in which the out of band signals are limited into signals in a time domain to output the signals in the time domain.

27. The apparatus as claimed in claim 26, wherein the out of band signal limiter comprises:
a Fast Fourier Transform (FFT) operator for performing FFT on the clipped signals in the time domain to convert the clipped signals in the time domain into signals in a frequency domain; and
a second IFFT operator for setting out of band periods in the signals in the frequency domain to 0 to perform IFFT.

28. The apparatus as claimed in claim 26, wherein the out of band signal limiter comprises:
a first converter for complex conjugate converting the output signals of the first IFFT operator so that the first IFFT operator performs IFFT; and
an out of band signal limiter for setting out of band periods in the signals in the frequency domain that are received from the first converter to 0 to output 0 to the first IFFT operator.

29. The apparatus as claimed in claim 26, further comprising a prototype filter for performing filtering to reduce interference of sub-carriers in the signals in which the out of band signals are limited.

30. A method of reducing clipping noise in a multi-carrier communication system in which a clipping method is used, the method comprising the steps of:
when clipped signals are received, decoding and equalizing received signals to determine transmitted symbols;
comparing magnitudes of the amplitudes of the determined transmitted symbols with a predetermined reference value; and
reconstructing signals using the amplitudes of the transmitted symbols and the phases of the received signals when it is determined that the magnitudes of the amplitudes of the transmitted symbols are greater than the reference value.

31. The method as claimed in claim 30, wherein the reference value is a clipping ratio.

32. The method as claimed in claim 30, further comprising reconstructing signals using the amplitudes and the phases of the received signals when it is determined that the magnitudes of the amplitudes of the transmitted symbols are less than or equal to the reference value.

33. The method as claimed in claim 30, further comprising:
re-generating out of band signals limited by a transmitting end using the determined transmitted symbols when the received signals are over-sampled;
adding the re-generated out of band signals to the received signals; and
reconstructing signals using the received signals to which the out of band signals are added when it is determined that the magnitudes of the amplitudes of the transmitted symbols are less than or equal to the reference value.

34. The method as claimed in claim 33, wherein re-generating the out of band signals comprises:
performing Inverse Fast Fourier Transform (IFFT) on the determined transmitted symbols to convert the determined transmitted symbols into signals in a time domain;
clipping the signals in the time domain in a clipping ratio which is the same as a clipping ratio in which clipping is performed by the transmitting end; and
limiting in-band signals after converting the clipped signals into signals in a frequency domain.

35. The method as claimed in claim 33, further comprising reconstructing signals using the amplitudes of the transmitted symbols and phases of the received signals to which the out of band signals are added when it is determined that the magnitudes of the amplitudes of the transmitted symbols are greater than the reference value.

36. The method as claimed in claim 30, wherein the transmitted symbols are determined by performing a hard decision.

37. The method as claimed in claim 30, wherein reconstructing the signals further comprises:
performing Inverse Fast Fourier Transform (IFFT) on the transmitted symbols; and
performing IFFT on the received signals, and wherein the step of reconstructing the signals is performed in a time domain.

38. A method of reducing clipping noise in a multi-carrier communication system in which a clipping method is used, the method comprising the steps of:
when clipped signals are received, decoding and equalizing received signals to determine transmitted symbols;
re-generating out of band signals limited by a transmitting end using the determined transmitted symbols;
adding the re-generated out of band signals to the received signals; and
comparing magnitudes of the amplitudes of the transmitted symbols with a predetermined reference value to reconstruct signals in accordance with the comparison result.

39. The method as claimed in claim 38, wherein the reference value is a clipping ratio.

40. The method as claimed in claim 38, further comprising reconstructing signals using the transmitted symbols when it is determined that the magnitudes of the amplitudes of the transmitted symbols are greater than the reference value.

41. The method as claimed in claim 38, further comprising reconstructing signals using the received signals to which the out of band signals are added when it is determined that the magnitudes of the amplitudes of the transmitted symbols are less than or equal to the reference value.

42. The method as claimed in claim 38, wherein re-generating the out of band signals comprises:
performing Inverse Fast Fourier Transform (IFFT) on the determined transmitted symbols to convert the determined transmitted symbols into signals in a time domain;
clipping the signals in the time domain in a clipping ratio which is the same as a clipping ratio in which clipping is performed by the transmitting end; and
limiting in-band signals after converting the clipped signals into signals in a frequency domain.

43. The method as claimed in claim 38, wherein the transmitted symbols are determined by performing a hard decision.

44. The method as claimed in claim 38, wherein reconstructing the signals further comprises:
performing Inverse Fast Fourier Transform (IFFT) on the transmitted symbols; and
performing IFFT on the received signals, and wherein reconstructing the signals is performed in a time domain.

45. A method of re-generating out of band signals limited by a transmitting end in a multi-carrier communication system, the method comprising the steps of:
when signals in which out of band signals are limited are received, decoding and equalizing the received signals to determine transmitted symbols;
clipping the determined transmitted symbols in a clipping ratio which is the same as a clipping ratio in which clipping is performed by the transmitting end;
limiting in-band signals of the clipped signals; and
adding the clipped signals in which the in-band signals are limited to the received signals.

46. The method as claimed in claim 45, wherein clipping the determined transmitted symbols comprises:
performing Inverse Fast Fourier Transform (IFFT) on the transmitted symbols to convert the transmitted symbols into signals in a time domain; and
clipping the signals in the time domain in the same clipping ratio as the clipping ratio in which clipping is performed by the transmitting end.

47. The method as claimed in claim 45, wherein limiting the in-band signals:
performing Fast Fourier Transform (FFT) on the clipped signals to convert the clipped signals into signals in a frequency domain; and
limiting in-band signals in the signals in the frequency domain.
